(19) United States
(12) Patent Application Publication
(10) Pub. No.: US 2015/0181472 A1
(43) Pub. Date: Jun. 25, 2015

(54) ESR Extension for LTE TDD to FDD Redirection for VoLTE

(71) Applicant: Apple Inc., Cupertino, CA (US)

(72) Inventors: Farouk Belghoul, Cupertino, CA (US); Tarik Tabet, San Jose, CA (US); Rafael L. Rivera-Barreto, Cupertino, CA (US); Samy Khay-Ibbat, Cupertino, CA (US); Sree Ram Kodali, Cupertino, CA (US); Sarma V. Vangala, Cupertino, CA (US); Syed A. Mujtaba, Cupertino, CA (US); Swaminathan Balakrishnan, Cupertino, CA (US)

(21) Appl. No.: 14/503,187

(22) Filed: Sep. 30, 2014

Related U.S. Application Data
(60) Provisional application No. 61/919,687, filed on Dec. 20, 2013.

(51) Int. Cl. H04W 36/00; H04L 5/14; H04W 36/30

(52) U.S. Cl. CPC H04W 36/0022; H04W 36/30; H04L 5/14; H04W 88/06

(57) ABSTRACT

This application presents techniques for an LTE user equipment (UE) to use an extended service request (ESR) extension for LTE TDD to FDD redirection for mobile originated and mobile terminated VoLTE calls. These techniques include the UE informing the network that it supports the particular features of the ESR extensions presented. Once the UE attaches to the network, a radio resource control (RRC) message can be sent to indicate that the UE supports the new ESR extension, after which the UE can use the new ESR extension to facilitate an LTE TDD to FDD redirection for the VoLTE call.

### PRIORITY CLAIM

This application claims the benefit of priority from U.S. Provisional Patent Application Ser. No. 61/919,687, entitled “VoLTE: ESR Extension for LTE TDD to FDD Redirection” and filed Dec. 20, 2013, which is fully incorporated herein by reference for all purposes to the extent not inconsistent with this application.

### BACKGROUND

1. Field of the Application

The disclosure is directed to wireless communications and, more particularly, to voice-over LTE (VoLTE) and extended service request (ESR) extension for LTE TDD to FDD redirection for VoLTE.

2. Background of the Disclosure

Wireless communication systems are widely deployed to provide various communication services, such as: voice, video, packet data, circuit-switched info, broadcast, messaging services, and so on. A typical wireless communication system, or network, can provide multiple users access to one or more shared resources (e.g., bandwidth, transmit power, etc.). These systems can be multiple-access systems that are capable of supporting communication for multiple terminals by sharing available system resources. Examples of such multiple-access systems include Code Division Multiple Access (CDMA) systems, Time Division Multiple Access (TDMA) systems, Frequency Division Multiple Access (FDMA) systems and Orthogonal Frequency Division Multiple Access (OFDMA) systems.

Generally, a wireless multiple-access communication system can simultaneously support communication for multiple wireless devices or terminals. In such a system, each terminal can communicate with one or more base stations via transmissions on the forward and reverse links. The forward link (or downlink) refers to the communication link from the base stations to the terminals, and the reverse link (or uplink) refers to the communication link from the terminals to the base stations. This communication link can be established via a single-in-single-out (SISO), single-in-multiple-out (SIMO), multiple-in-signal-out (MISO), or a multiple-in-multiple-out (MIMO) system.

For instance, a MIMO system can employ multiple (N_{T}) transmit antennas and multiple (N_{R}) receive antennas for data transmission. A MIMO channel formed by the N_{T} transmit and N_{R} receive antennas can be decomposed into Nₛ independent channels, which are also referred to as spatial channels, where N_{S}≦min {N_{T}, N_{R}}. Each of the N_{S} independent channels can correspond to a dimension. The MIMO system can provide improved performance (e.g., higher throughput and/or greater reliability) if the additional dimensionalities created by the multiple transmit and receive antennas are utilized.

A MIMO system can support a time division duplex (TDD) and frequency division duplex (FDD) systems. In an FDD system, the transmitting and receiving channels are separated with a guard band (some amount of spectrum that acts as a buffer or insulator), which allows two-way data transmission by, in effect, opening two distinct radio links. In a TDD system, only one channel is used for transmitting and receiving, separating them by different time slots. No guard band is used. This can increase spectral efficiency by eliminating the buffer band and can also increase flexibility in asynchronous applications. For example, if less traffic travels in the uplink, the time slice for that direction can be reduced, and reallocated to downlink traffic.

Modern wireless communication systems use 3GPP Long-Term Evolution (LTE), which is optimized for data transfer and designed as a packet switched system only. LTE does not include any circuit switched domains, which are currently used for regular wireless voice services and wireless short messaging service (SMS) services. To implement voice capability in an LTE communication system, voice-over LTE (VoLTE) will be used and various network elements and protocols will need to be upgraded to effective support VoLTE. Therefore what is needed are effective systems and software for implementing an operable VoLTE network.

### BRIEF DESCRIPTION OF THE DRAWINGS

FIG. 1 illustrates an exemplary wireless multiple-access communication system according to certain embodiments;

FIG. 2 illustrates a block diagram of an exemplary mobile device or user equipment (UE) according to certain embodiments;

FIG. 3 illustrates a block diagram of an exemplary enhanced Node B (eNB) or similar mobile communication node (e.g., base station, access point, etc.) according to certain embodiments;

FIG. 4 illustrates an exemplary multi-RAT wireless network according to certain embodiments;

FIG. 5 illustrates an exemplary UE solution flowchart for mobile originated (MO) calls according to certain embodiments;

FIG. 6 illustrates an exemplary mobile originated (MO) call signaling flow with the UE connected according to certain embodiments;

FIG. 7 illustrates an exemplary UE solution flowchart for UE-connected, mobile terminated (MT) calls according to certain embodiments;

FIG. 8 illustrates an exemplary UE solution flowchart for UE-idle, mobile terminated (MT) calls according to certain embodiments; and

FIG. 9 illustrates an exemplary mobile terminated (MT) call signaling flow with the UE connected according to certain embodiments.

### DETAILED DESCRIPTION

The following detailed description is directed to certain sample embodiments. However, the disclosure can be embodied in a multitude of different ways as defined and covered by the claims. In this description, reference is made to the drawings wherein like parts are designated with like numerals within this application.

This disclosure makes reference to various wireless communication devices, such as access point, mobile device, base station, user equipment, Node B, access terminal and eNB. The use of these and other names is not intended to indicate or mandate one particular device, one particular standard or protocol, or one particular signaling direction and is expressly intended to not be limiting of the scope of this application in any way. The use of these and other names is strictly for convenience and such names may be interchanged within this application without any loss of coverage or rights.

Various techniques described herein can be used for various wireless communication systems, such as Code Division Multiple Access (“CDMA”) systems, Multiple-Carrier CDMA (“MCCDMA”), Wideband CDMA (“W-CDMA”), High-Speed Packet Access (“HSPA,” “HSPA+”) systems, Time Division Multiple Access (“TDMA”) systems, Frequency Division Multiple Access (“FDMA”) systems, Single-Carrier FDMA (“SC-FDMA”) systems, Orthogonal Frequency Division Multiple Access (“OFDMA”) systems, or other multiple access techniques. A wireless communication system employing the teachings herein may be designed to implement one or more standards, such as IS-95, CDMA2000, IS-856, W-CDMA, TDSCDMA, and other standards. A CDMA network may implement a radio technology such as Universal Terrestrial Radio Access (“UTRA)”, CDMA2000, or some other technology. UTRA includes W-CDMA and Low Chip Rate (“LCR”). The CDMA2000 technology covers IS-2000, IS-95 and IS-856 standards. A TDMA network may implement a radio technology such as Global System for Mobile Communications (“GSM”). An OFDMA network may implement a radio technology such as Evolved UTRA (“E-UTRA”), IEEE 802.11 (“WiFi”), IEEE 802.16 “(WiMAX”), IEEE 802.20 (“MBWA”), Flash-OFDM.RTM., etc. UTRA, E-UTRA, and GSM are part of Universal Mobile Telecommunication System (“UMTS”). The teachings herein may be implemented in a 3GPP Long Term Evolution (“LTE”) system, an Ultra-Mobile Broadband (“UMB”) system, and other types of systems. LTE is a release of UMTS that uses E-UTRA. Although certain aspects of the disclosure may be described using 3GPP terminology, it is to be understood that the teachings herein may be applied to 3GPP (Re199, Re15, Re16, Re17) technology, as well as 3GPP2 (IxRTT, 1xEV-DO RelO, RevA, RevB) technology and other technologies, such as WiFi, WiMAX, WMBA and the like.

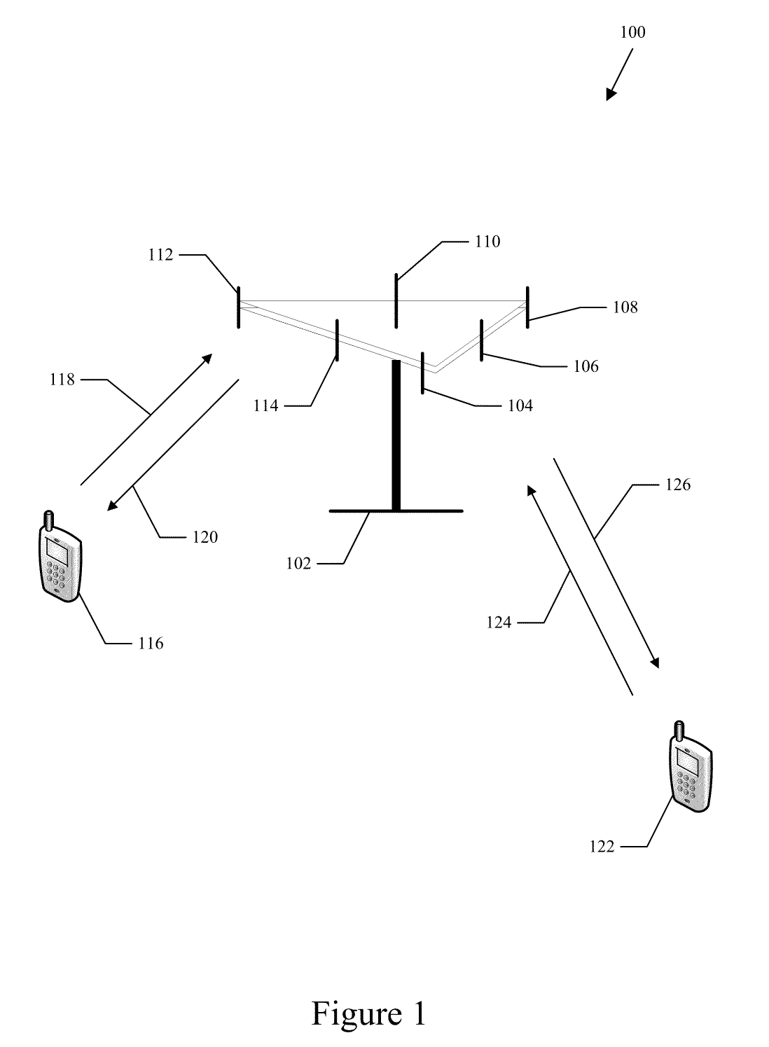

Referring now to the drawings, FIG. 1 illustrates an exemplary wireless multiple-access communication system 100 according to certain embodiments. In one example, an enhanced Node B (eNB) base station 102 includes multiple antenna groups. As shown in FIG. 1, one antenna group can include antennas 104 and 106, another can include antennas 108 and 110, and another can include antennas 112 and 114. While only two antennas are shown in FIG. 1 for each antenna group, it should be appreciated that more or fewer antennas may be utilized for each antenna group. As shown, user equipment (UE) 116 can be in communication with antennas 112 and 114, where antennas 112 and 114 transmit information to UE 116 over downlink (or forward link) 120 and receive information from UE 116 over uplink (or reverse link) 118. Additionally and/or alternatively, UE 122 can be in communication with antennas 104 and 106, where antennas 104 and 106 transmit information to UE 122 over downlink 126 and receive information from US 122 over uplink 124. In a frequency division duplex (FDD) system, communication links 118, 120, 124 and 126 can use different frequencies for communication. In time division duplex (TDD) systems, the communication links can use the same frequency for communication, but at differing times.

Each group of antennas and/or the area in which they are designed to communicate can be referred to as a sector of the eNB or base station. In accordance with one aspect, antenna groups can be designed to communicate to mobile devices in a sector of areas covered by eNB 102. In communication over downlinks 120 and 126, the transmitting antennas of eNB 102 can utilize beamforming in order to improve the signal-to-noise ratio of downlinks for the different UEs 116 and 122. Also, a base station using beamforming to transmit to UEs scattered randomly through its coverage causes less interference to mobile devices in neighboring cells than a base station transmitting through a single antenna to all its UEs. In addition to beamforming, the antenna groups can use other multi-antenna techniques, such as spatial multiplexing, spatial diversity, pattern diversity, polarization diversity, transmit/receive diversity, adaptive arrays, etc.

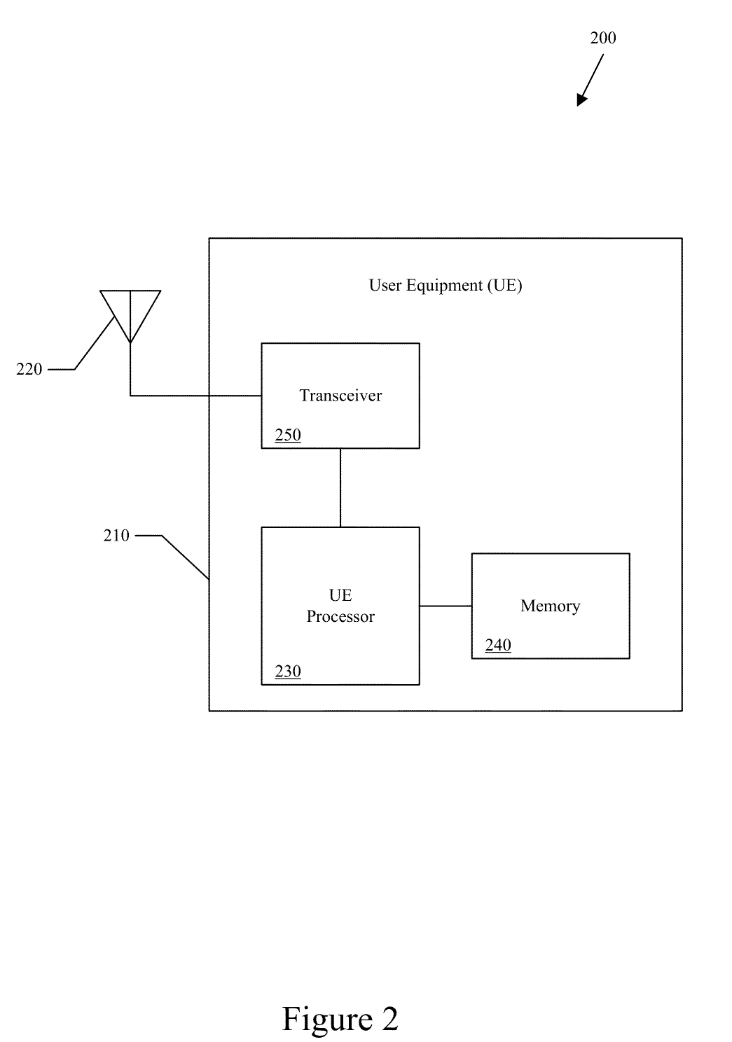

FIG. 2 illustrates a block diagram 200 of an exemplary mobile device or user equipment (UE) 210 according to certain embodiments. As shown in FIG. 2, UE 210 may include a transceiver 250, an antenna 220, a processor 230, and a memory 240 (which, in certain embodiments, may include memory in a Subscriber Identity Module (SIM) card). In certain embodiments, some or all of the functionalities described herein as being performed by mobile communication devices may be provided by processor 230 executing instructions stored on a computer-readable medium, such as the memory 240, as shown in FIG. 2. Additionally, UE 210 may perform uplink and/or downlink communication functions, as further disclosed herein, via transceiver 250 and antenna 220. While only one antenna is shown for UE 210, certain embodiments are equally applicable to multi-antenna mobile devices. In certain embodiments, UE 210 may include additional components beyond those shown in FIG. 2 that may be responsible for enabling or performing the functions of UE 210, such as communicating with a base station in a network and for processing information for transmitting or from reception, including any of the functionality described herein. Such additional components are not shown in FIG. 2 but are intended to be within the scope of coverage of this application.

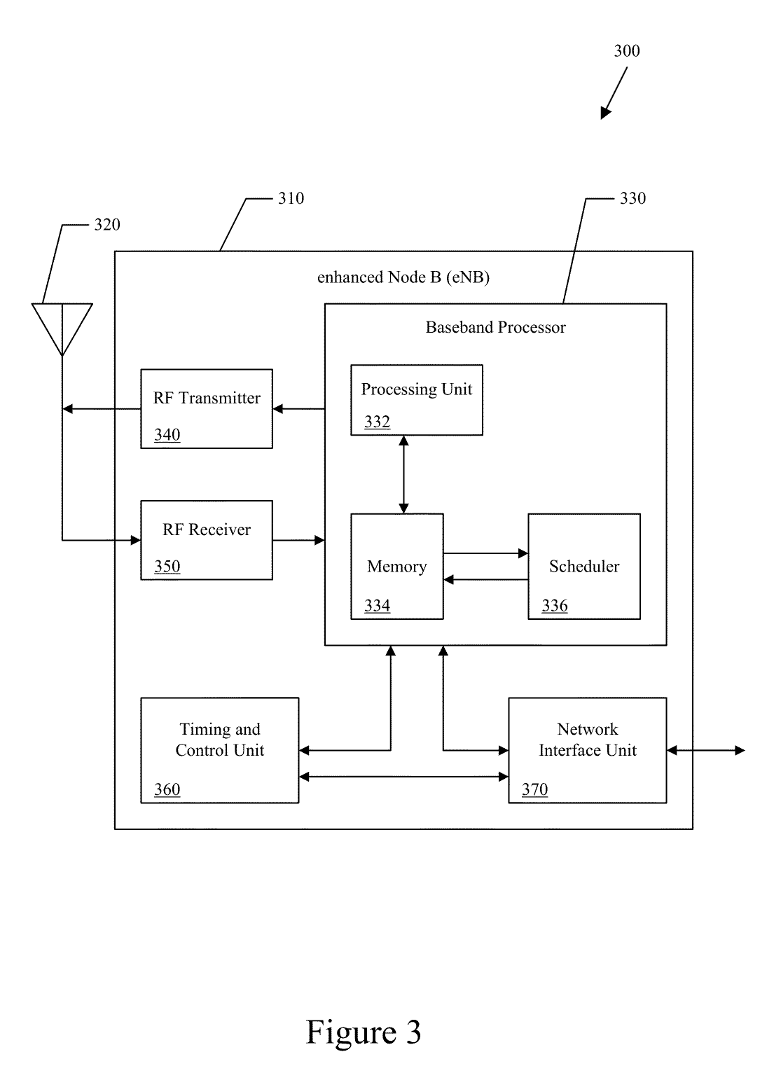

FIG. 3 illustrates a block diagram 300 of an exemplary enhanced Node B (eNB) 310 or similar mobile communication node (e.g., base station, access point, etc.) according to certain embodiments. As shown in FIG. 3, eNB 310 may include a baseband processor 310 to provide radio communication with mobile handsets via a radio frequency (RF) transmitter 340 and RF receiver 330 units coupled to the eNB antenna 320. While only one antenna is shown, certain embodiments are applicable to multi-antenna configurations. RF transmitter 340 and RF receiver 330 may be combined into one, transceiver unit, or duplicated to facilitate multiple antenna connections. Baseband processor 320 may be configured (in hardware and/or software) to function according to a wireless communications standard, such as 3GPP LTE. Baseband processor 320 may include a processing unit 332 in communication with a memory 334 to process and store relevant information for the eNB and a scheduler 336, which may provide scheduling decisions for mobile devices serviced by eNB 310. Scheduler 336 may have some or all of the same data structure as a typical scheduler in an eNB in an LTE system.

Baseband processor 330 may also provide additional baseband signal processing (e.g., mobile device registration, channel signal information transmission, radio resource management, etc.) as required. Processing unit 332 may include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Some or all of the functionalities described herein as being provided by a mobile base station, a base station controller, a node B, an enhanced node B, an access point, a home base station, a femtocell base station, and/or any other type of mobile communications node may be provided by processing unit 332 executing instructions stored on a computer-readable data storage medium, such as the memory 334 shown in FIG. 3.

In certain embodiments, eNB 310 may further include a timing and control unit 360 and a core network interface unit 370, such as are shown in FIG. 3. Timing and control unit 360 may monitor operations of baseband processor 330 and network interface unit 370, and may provide appropriate timing and control signals to these units. Network interface unit 370 may provide a bi-directional interface for eNB 310 to communicate with a core or back-end network (not shown) to facilitate administrative and call-management functions for mobile subscribers operating in the network through eNB 310.

Certain embodiments of the base station 310 may include additional components responsible for providing additional functionality, including any of the functionality identified herein and/or any functionality necessary to support the solution described herein. Although features and elements are described in particular combinations, each feature or element can be used alone without the other features and elements or in various combinations with or without one or more features and elements. Methodologies provided herein may be implemented in a computer program, software, or firmware incorporated in a computer-readable storage medium (e.g., memory 334 in FIG. 3) for execution by a general purpose computer or a processor (e. g., processing unit 332 in FIG. 3). Examples of computer-readable storage media include read only memory (ROM), random access memory (RAM), digital registers, cache memory, semiconductor memory devices, magnetic media such as internal hard disks, magnetic tapes and removable disks, magneto-optical media, and optical media such as CDROM disks, digital versatile disks (DVDs), and so on.

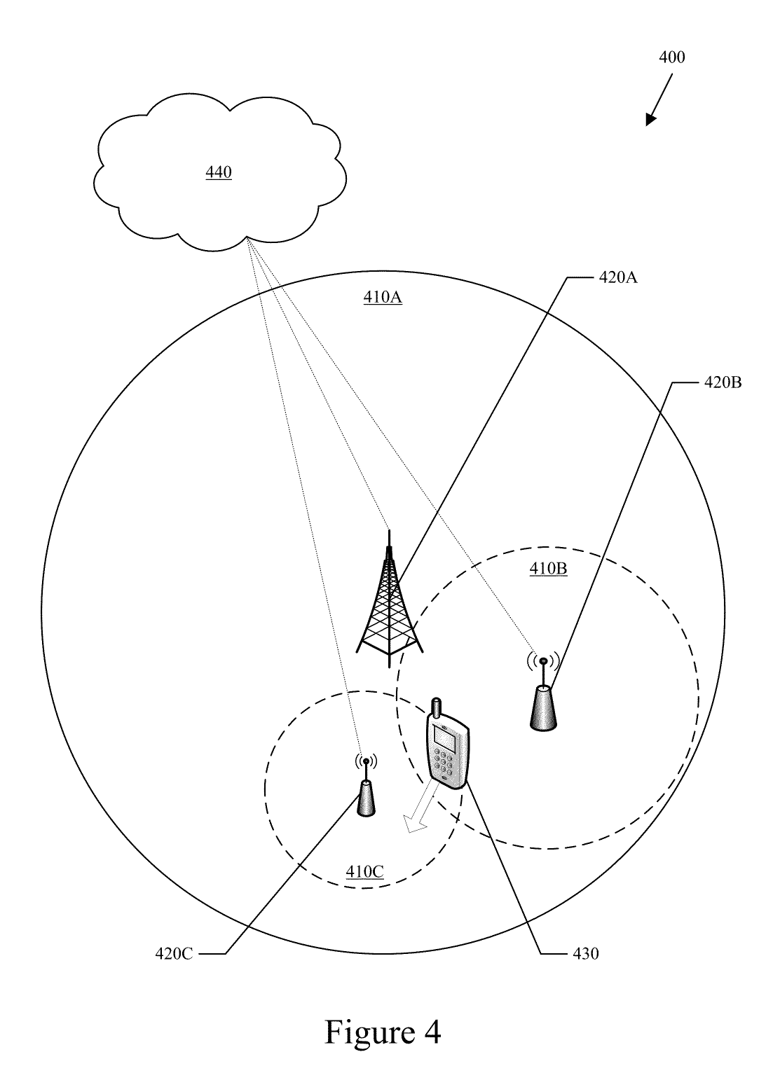

FIG. 4 illustrates an exemplary multi-RAT (radio access technology) wireless network 400 according to certain embodiments. As shown in FIG. 4, a mobile device (handset, UE, etc.) 430 is within the coverage area of multi-RAT wireless network 400. Multi-RAT wireless network 400 can include multiple network coverage pieces. For example, the once coverage area can be a cell 410A, such as in an LTE coverage area or TD-LTE coverage area. Within (or partially within) cell 410A coverage area, there can concurrently exist one or more other coverage areas, or cells 410B and 410C, such as in an FDD-LTE, GSM, WiMAX, CDMA or even Wi-Fi coverage area. As shown, cells 410B, 410C are within cell 410A and at least partially overlap each other, although this configuration is for illustrative purposes only. Each cell 410 can also include some sort of network access device 420A, 420B and 420C, such as a base station, eNodeB or access point. Each network access device 420 can communicate with one or more mobile devices 430, as well as with a core network 440. Not shown are possible intermediate network components or system elements that may be between each network access device 420 and core network 440. In certain embodiments, mobile device 430 can be moving within cell 410A and moving out of cell 410B and into cell 410C. In this way, mobile device 430 could possibly communicate with one or more of cells 410A, 410B and 410C.

Long-Term Evolution (LTE) is optimized for data transfer and designed as a packet switched all-IP system only; it does not include a circuit switched domain, such as is currently used for regular voice and short message service (SMS) services. To implement voice capability in an LTE environment, voice-over LTE (VoLTE) will be used (which, generally, can be considered as similar to voice over Internet protocol (VoIP) used for in-home, wired telephony). In order for VoLTE to run over an LTE network, an IMS (IP Multimedia System) core network needs to provide the telephony service over IP. MMTel (Multimedia Telephony, deployed on the IP Multimedia Service (IMS) core) is the solution that provides the telephony service (and other services, such as presence, video calling, chat, and so on) in both LTE and fixed networks. The LTE radio access network and the evolved packet core (EPC) also need to support VoLTE, which can be achieved by software upgrades.

By definition, the VoLTE profile specifies IMS-based voice services over LTE. However, the architecture used for VoLTE can be used to deliver high-quality communication services over any packet switched access capable of securing the necessary quality of service (QoS). VoLTE specifications are modular and the upper layers of IMS control/applications are reusable for other packet-switched access types and the same service definitions can be used.

Consumers will be able to use operator-provided high-definition (HD) voice, video calling and other communication services (e.g., chat, presence, and more) on LTE smartphones and other devices. These services use a regular mobile phone number (e.g., mobile subscriber integrated services digital network number or MSISDN number), and VoLTE brings the operator telephony values into an all-IP mobile broadband network: global interoperability, Quality of Service, roaming and seamless mobility, between any mobile devices, over any access. With VoLTE, both voice and LTE data services can be used simultaneously on VoLTE smartphones.

LTE radio technologies can be deployed as time division (TD-LTE) or frequency division (FDD LTE) configurations. TD-LTE and FDD LTE cells can be deployed in the same area. TD and FDD converged networks can share the same core network. User equipment, or mobile devices, can perform handover and/or cell reselection between TD and FDD cells. LTE itself does not support circuit switched (CS) voice calls. CS voice calls are carried out on 2G/3G networks. A procedure known as circuit switched fallback protocol (CSFB) has been used to switch a UE to/from LTE and 2G/3G networks for CS voice calls. CSFB is based on extended service request (ESR) procedures. Generally, the UE sends an ESR message to the network to initiate a CSFB call or respond to an MT CSFB request from the network. The ESR message is also used if the UE wants to request the establishment of a non-access stratum (NAS) signaling connection (and of the radio and Si bearers) for packet services and if the UE needs to provide additional information that cannot be provided via a regular service request message. Voice-over IP for LTE (VoLTE) is the standardized voice telephony technology for TD-LTE and FDD LTE. VoLTE is based on IMS/SIP (session initiation protocol).

For the remainder of this application, the following items are assumed to help focus the understanding of the disclosure, but are not meant to be limiting of the scope of the claims. The UE is located in TDD and FDD LTE coverage areas, which are within the same core network. The UE supports both TDD and FDD LTE. The UE can be in connected or idle mode, and can be connected to the network through a TDD cell. Both the UE and network (NW) can support VoLTE features/configuration. For regulatory reasons, the UE cannot perform any call (voice/video/etc.) over TDD cells. The UE can use any TDD or FDD cells but can perform and receive VoLTE calls only in FDD cells.

In certain embodiments, this disclosure presents a mechanism whereby the UE can tell the NW that it supports the particular features of ESR for TDD-FDD handover for VoLTE as discussed herein. Such a mechanism could be agreed upon between the NW and the UE. Once the UE attaches to the NW, a radio resource control (RRC) message can be sent to indicate that the UE supports the new ESR feature presented herein. Examples of such RRC messages in LTE can include, but is not limited to: RAT-type, UE-EUTRA-Capability, FGI (feature group indicator), and so on.

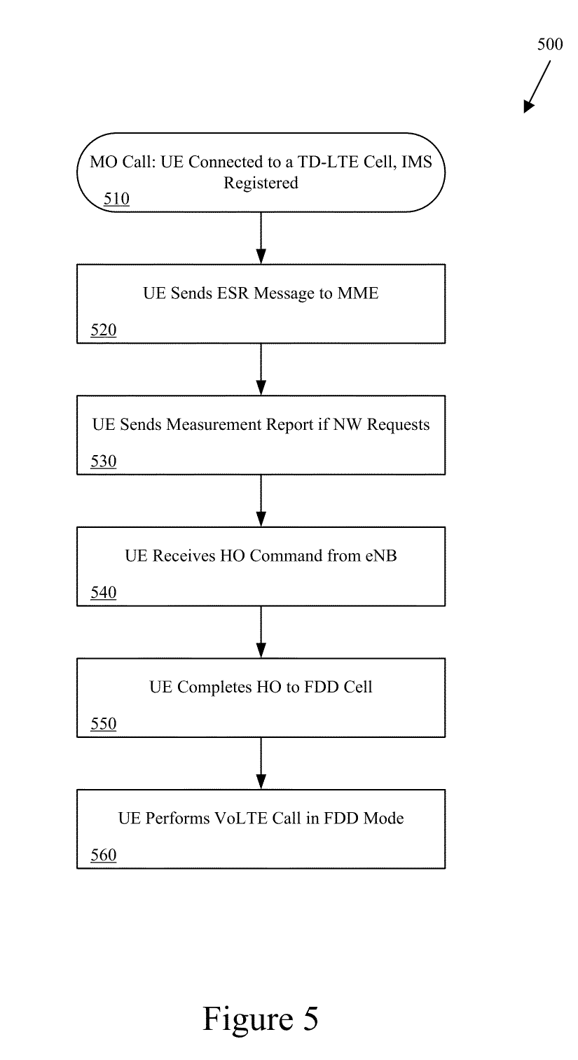

In certain embodiments, this disclosure presents a mechanism by which the UE and the network can control the LTE technology (TDD or FDD) for originating and terminating VoLTE calls. When the UE is camped in the network (NW) through an FDD cell, the UE can originate a VoLTE call using basic 3GPP mechanisms. FIG. 5 illustrates an exemplary UE solution flowchart 500 for mobile originated (MO) calls according to certain embodiments. As shown in FIG. 5, at 510, the UE is camped in a TD-LTE cell and is in RRC connected mode. At 520, the UE can generate an extended service request (ESR) message to the mobility management entity (MME). The service type request can be mobile originated (MO) FDD fallback. When the NW receives this message, at 530, it can request that that the UE send a measurement report, if no measurements are already available, and thus prepare the handover (HO). At 540, the eNB can generate an HO command for the UE to handover to an FDD cell. When, at 550, the HO is successful, the UE, at 560, can perform the VoLTE call in FDD mode.

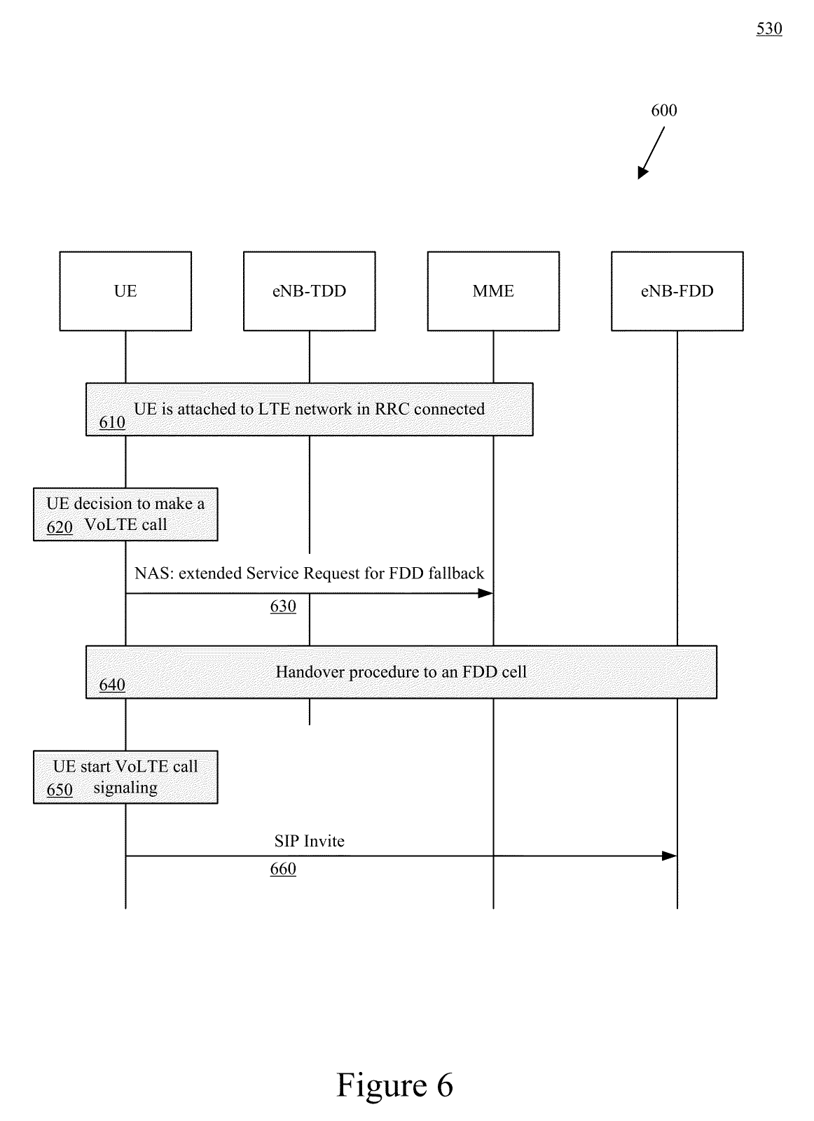

FIG. 6 illustrates an exemplary mobile originated (MO) call signaling flow 600 with the UE connected according to certain embodiments. Call signaling flow 600 can be as represented and discussed with reference to FIG. 5. As shown in FIG. 6, the UE is attached to the LTE network in RRC connected mode 610. The UE receives/creates the decision to make a VoLTE call 620. The UE can signal the MME with an extended service request message for FDD fallback 630. The UE can perform a handover procedure to an FDD cell 640. Once in the FDD cell, the UE can start VoLTE call signaling 650. The UE can send a SIP invite 600 on the FDD cell 660.

In certain embodiments, as applied to FIG. 5 and/or 6, if the UE is camped on a TD-LTE cell and the UE is in RRC idle mode, instead of connected mode, the UE can perform an idle reselection procedure, instead of a handover procedure, to the best available FDD cell and then initiate a VoLTE call in FDD mode.

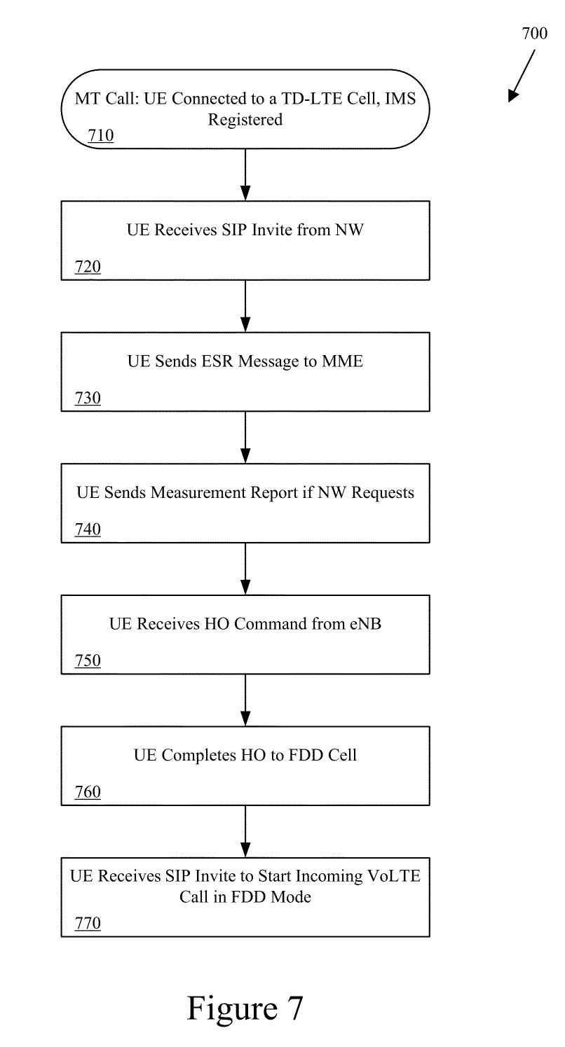

In certain embodiments, when the UE is to receive an incoming mobile terminated (MT) call and is camped in the NW through an FDD cell, the UE can receive the incoming MT VoLTE call using basic 3GPP mechanisms. However, FIG. 7 illustrates an exemplary UE solution flowchart 700 for UE-connected, mobile terminated (MT) calls according to certain embodiments. As shown in FIG. 7, at 710, the UE is camped in a TD-LTE cell and the UE is in RRC connected mode. At 720, the network (NW) can generate and send a session initiation protocol (SIP) invite, which the UE receives. Upon receiving the SIP invite, at 730, the UE can generate and send an ESR message to the MME, with service type set to mobile terminating FDD fallback. When the NW receives this message, at 740, it can request that the UE send a measurement report, if no measurements already available at the network, and prepare for handover (HO). At 750, the eNB generates and sends to the UE a HO command in the direction to FDD cells. At 760, once the HO is successful, then at 770, the UE receives the SIP invite from the NW to start the incoming VoLTE call signaling.

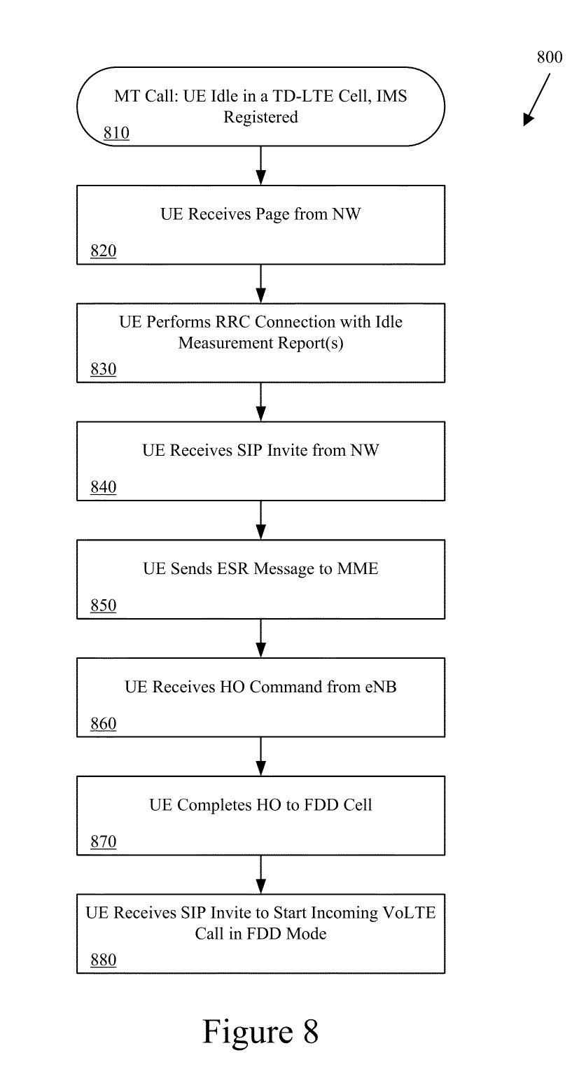

FIG. 8 illustrates an exemplary UE solution flowchart 800 for UE-idle, mobile terminated (MT) calls according to certain embodiments. At 810, the UE is camped on a TD-LTE cell and the UE is in RRC idle mode. At 820, the NW can send a paging message, which the UE receives. At 830, the UE can perform an RRC connection request with an idle measurement reports. At 840, the UE receives the SIP invite sent from the NW and at 850 it generates and sends the ESR request to MME, with service type set to mobile terminating FDD fallback. At 860, the NW initiates a HO to the UE/VoLTE suitable FDD cell. At 870, once the UE completes the HO procedure to the FDD cell, then at 880 it can receive a SIP invite sent by the NW to the UE in the FDD cells to start the incoming VoLTE call signaling.

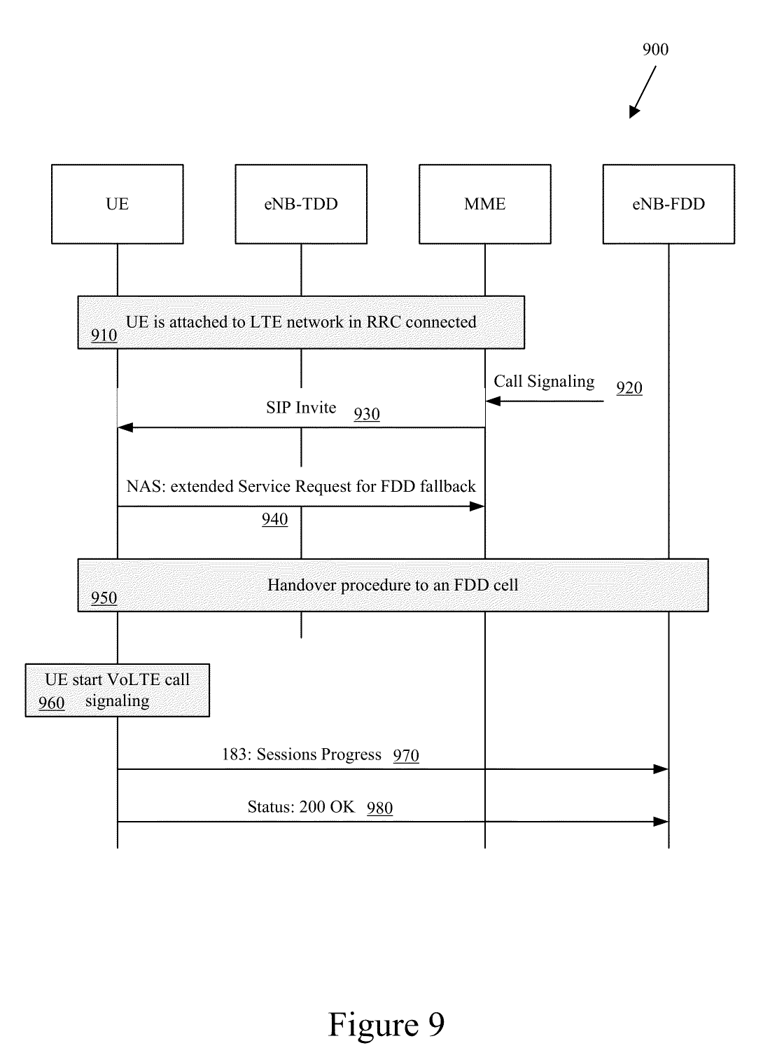

FIG. 9 illustrates an exemplary mobile terminated (MT) call signaling flow with the UE connected according to certain embodiments. Call signaling flow 900 can be as represented and discussed with reference to FIG. 7 (and by extension, FIG. 8). As shown in FIG. 9, the UE is attached to the LTE network in RRC connected mode 910. Call signaling 920 can initiate an SIP invite 930. The UE can signal the MME with an extended service request message for FDD fallback 940. The UE can perform a handover procedure to an FDD cell 950. Once in the FDD cell, the UE can start VoLTE call signaling 960. Additionally, the UE can use a 183 (session progress) response, which can be used to convey information about the progress of the call 970, and a 200 (OK) status response.

Those of ordinary skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of ordinary skill would further appreciate that the various illustrative logical blocks, modules, and algorithm steps described in connection with the examples disclosed herein may be implemented as electronic hardware, firmware, computer software, middleware, microcode, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints or preferences imposed on the overall system. Skilled artisans may implement the described functionality in varying ways for each particular application, but such implementation decisions should not be interpreted as causing a departure from the scope of this disclosure.

The various illustrative logical blocks, components, modules, and circuits described in connection with the examples disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the examples disclosed herein may be embodied directly in hardware, in one or more software modules executed by one or more processing elements, or in a combination of the two. A software module may reside in RAM memory, flash memory, ROM memory, EPROM memory, EEPROM memory, registers, hard disk, a removable disk, a CD-ROM, or any other form or combination of storage medium known in the art. An example storage medium is coupled to the processor such that the processor can read information from, and write information to, the storage medium. In the alternative, the storage medium may be integral to the processor. The processor and the storage medium may reside in an Application Specific Integrated Circuit (ASIC). The ASIC may reside in a wireless modem. In the alternative, the processor and the storage medium may reside as discrete components in the wireless modem.

The previous description of the disclosed examples is provided to enable any person of ordinary skill in the art to make or use the disclosed methods and apparatus. Various modifications will be readily apparent to those skilled in the art, and the principles defined herein may be applied to other examples and additional elements may be added.

What is claimed is:

1. A method for making a mobile originated (MO) call by a mobile device in a time-division Long-Term Evolution (TD-LTE) wireless communication cell, the mobile device being voice over LTE (VoLTE) capable, comprising:
sending an extended service request (ESR) message;
receiving a handover command to a frequency division duplexed LTE (FDD LTE) cell;
completing a handover to the FDD LTE cell; and
performing a VoLTE call in FDD mode.

2. The method of claim 1, further comprising, prior to sending the ESR message:
sending a radio resource control (RRC) message indicating that the mobile device supports VoLTE ESR messaging.

3. The method of claim 2, where the RRC message includes one or more of a radio access technology (RAT) type message, a user equipment evolved universal terrestrial radio access (UE-EUTRA) capability message and feature group indicators (FGIs).

4. The method of claim 1, wherein a service type for the ESR message can be a MO FDD LTE fallback.

5. The method of claim 1, further comprising, after sending the ESR message:
receiving a request for a measurement report of neighbor cells; and
sending the measurement report of the neighbor cells.

6. A mobile device for making a mobile originated (MO) call while in a time-division Long-Term Evolution (TD-LTE) wireless communication cell, the mobile device being voice over LTE (VoLTE) capable, comprising a processor configured for:
sending a radio resource control (RRC) message indicating that the mobile device supports VoLTE extended service request (ESR) messaging;
sending an ESR message;
receiving a handover command to a frequency division duplexed LTE (FDD LTE) cell;
completing a handover to the FDD LTE cell; and
performing a VoLTE call in FDD mode.

7. The mobile device of claim 6, where the RRC message includes one or more of a radio access technology (RAT) type message, a user equipment evolved universal terrestrial radio access (UE-EUTRA) capability message and feature group indicators (FGIs).

8. The mobile device of claim 6, wherein a service type for the ESR message can be a MO FDD LTE fallback.

9. The mobile device of claim 6, wherein, after sending the ESR message, the processor is further configured for:
receiving a request for a measurement report of neighbor cells; and
sending the measurement report of the neighbor cells.

10. A computer-program storage apparatus for making a mobile originated (MO) call by a mobile device in a time-division Long-Term Evolution (TD-LTE) wireless communication cell, the mobile device being voice over LTE (VoLTE) capable, comprising a memory having one or more software modules stored thereon, the one or more software modules being executable by one or more processors and the one or more software modules comprising:
code for sending an extended service request (ESR) message;
code for completing a handover to a frequency division duplexed LTE (FDD LTE) cell; and
code for performing a VoLTE call in FDD mode.

11. The apparatus of claim 10, wherein, prior to sending the ESR message, the one or more software modules further comprises:
code for sending a radio resource control (RRC) message indicating that the mobile device supports VoLTE ESR messaging.

12. The method of claim 11, where the RRC message includes one or more of a radio access technology (RAT) type message, a user equipment evolved universal terrestrial radio access (UE-EUTRA) capability message and feature group indicators (FGIs).

13. The apparatus of claim 10, wherein, prior to completing the handover, the one or more software modules further comprises:
code for receiving a handover command to the FDD LTE cell.

14. The apparatus of claim 10, wherein a service type for the ESR message can be a MO FDD LTE fallback.

15. The apparatus of claim 10, wherein, after sending the ESR message, the one or more software modules further comprises:
code for receiving a request for a measurement report of neighbor cells; and
code for sending the measurement report of the neighbor cells.
